(19) United States
(12) Patent Application Publication
(10) Pub. No.: US 2016/0102725 A1
(43) Pub. Date: Apr. 14, 2016

(54) ENERGY ABSORBER

(71) Applicant: SpanSet Inter AG, Wollerau (CH)

(72) Inventor: John P. Slaven, Manchester (GB)

(73) Assignee: SpanSet Inter AG, Wollerau (CH)

(21) Appl. No.: 14/974,439

(22) Filed: Dec. 18, 2015

Related U.S. Application Data
(63) Continuation of application No. PCT/EP2014/062730, filed on Jun. 17, 2014.

(30) Foreign Application Priority Data
Jun. 19, 2013 (GB) 1310888.1

(51) Int. Cl. F16F 7/12; A62B 35/00; A62B 35/04

(52) U.S. Cl. CPC F16F 7/123; A62B 35/04; A62B 35/0075

(57) ABSTRACT

An energy absorber comprising a housing for attachment to a first body, a deformer member mounted to the housing, a strip of plastically deformable material extending in a longitudinal direction between first and second ends, an attachment member provided at, or towards, the second end of the strip for attachment to a second body, the strip being arranged with the deformer member such that when a predetermined force is applied to the attachment member, the strip is moved relative to the deformer member from a first position in which a first section of the strip extends from the first end of the strip to the deformer member, to a second position in which at least a part of the first section of the strip is plastically deformed by the deformer member, wherein the strip is arranged such that when it is in its first position, the first section of the strip is substantially flat in the longitudinal direction of the first section of the strip.

The present invention relates to an energy absorber and, in particular, to a fall arrest shock absorber.

In many occupations it is necessary for a person to work in a dangerous environment, such as from a substantial height. In order to protect a person from falling in such an environment it is necessary, and often a legal requirement, to provide a safety line that is attached to the structure on which the person is working, which the person is attached to when working on the structure. Typically, first and second ends of the safety line are attached to the safety structure at first and second anchor points respectively. The safety line may be a horizontal or vertical safety line, to allow the person to travel in the horizontal or vertical directions, along the structure, respectively.

A person is generally attached to the safety line by a fall arrest traveller, which travels along the safety line with the person, to allow the person to move around the structure they are working on, while remaining attached to the safety line. If the person falls, the traveller locks onto the safety line to arrest their fall. This causes the kinetic energy of the person's fall to be transmitted through the safety line to the anchor point of the safety line.

Due to the rapid deceleration of the falling person the impact force that is transmitted to the anchor points of the safety line, when the fall arrest traveller locks onto the safety line, can be high enough to cause damage to the anchor points and/or the support structure. This is clearly dangerous, as it damages the integrity of the safety line and/or the building.

In an effort to address this problem, it is known to provide an energy absorber between an end of the safety line and the respective anchor point to the support structure.

One such energy absorber is disclosed in GB2357563 (Latchways Plc), which discloses an energy absorber comprising a housing for attachment to a support structure, with a coiled strip of plastically deformable material rotatably mounted within the housing. An end section of the coil is bent around first and second rollers, terminating in a free end that is provided outside of the housing. The free end of the coil is provided with a means of attachment to a safety line of a fall arrest system. When a person falls, the kinetic energy of the fall is transmitted through the safety line to the free end of the coil. This acts to pull the strip around the first and second rollers, so as to uncoil the strip and re-bend it around the rollers. This uncoiling and subsequent re-bending of the plastically deformable strip acts to absorb the energy of the fall, thereby reducing the force exerted by the safety line on the anchor point and vice versa.

However, this energy absorber suffers from the disadvantage that as the material is unwound from the coil, the diameter of the coil decreases, thereby resulting in an inconsistent, and non-linear, variation in the energy absorbing properties during a fall arrest. Although this problem is mitigated to an extent with the alternative helical coil arrangement disclosed in this document, manufacturing a helical coil is expensive and prone to malfunction during use.

In addition its energy absorbing properties, for example the amount of energy absorbed and the deflection of the strip for a certain level of force, cannot easily be varied, if at all. Therefore, the energy absorber is only suited to one particular application.

It is an object of the present invention to obviate or mitigate the aforementioned, and/or other disadvantages. It is also an object to provide for an alternative energy absorber.

According to a first aspect of the invention there is provided an energy absorber comprising a housing for attachment to a first body, a deformer member mounted to the housing, a strip of plastically deformable material extending in a longitudinal direction between first and second ends, an attachment member provided at, or towards, the second end of the strip for attachment to a second body, the strip being arranged with the deformer member such that when a predetermined force is applied to the attachment member, the strip is moved relative to the deformer member from a first position in which a first section of the strip extends from the first end of the strip to the deformer member, to a second position such that as the strip is moved from its first position to its second position at least a part of the first section of the strip is plastically deformed by the deformer member, wherein the strip is arranged such that when it is in its first position, the first section of the strip is substantially flat in the longitudinal direction of the first section of the strip.

Since the first section of the strip is substantially flat in its longitudinal direction, the energy absorber provides a consistent performance that can be accurately predicted according to the length of the strip. This provides a more linear force deflection graph, which has a larger area underneath its curve, relative to the known spiralled arrangement described above (in which the section of the strip that is disposed between the first end of the strip and the deformer member is wound in a spiralled coil that decreases in diameter decreasing as the strip is moved from its first position to its second position). Accordingly, with the fall arrest shock absorber of the present invention more work is performed by the deforming strip and so more energy is absorbed. In addition, the strip is relatively cheap and easy to manufacture and is less prone to malfunction in use.

Furthermore, the energy absorber is easy to recharge once it has been used by simply disassembling the frame and replacing the strip.

Preferably, when the strip is in its first position, the first section of the strip is also substantially flat in a lateral direction of the first section of the strip. Since the first section of the strip is substantially flat in both its longitudinal and lateral directions, it can be deformed by the deformer member in a linear fashion, thereby providing consistent performance. Furthermore, the strip is relatively cheap and simple to manufacture.

Preferably the strip is arranged such that when it is in its first position, the first section of the strip does not substantially enclose the first end of the strip. This is advantageous in that when the strip is in the first (un-deformed) position, the length of the strip can be easily varied, e.g. by attaching an additional length of strip to the first end of the strip, or removing a length of strip from its first end. This enables the shock absorbing properties, for example the amount of energy absorbed and the deflection of the strip for a certain level of force, to be varied as desired, in a quick, easy and reliable way.

Preferably when the strip is in its first position, the first end of the strip is exposed from the housing. This is advantageous in that it allows easy access to the first end of the strip, so as to vary the length of the strip, without having to disassemble the housing. This allows the energy absorbing properties of the strip to be varied quickly and easily, as desired. Preferably, when the strip is in its first position, the first end of the strip is provided outside of the housing.

Preferably when the strip is in its first and/or second position, the second end of the strip is exposed from the housing. Preferably when the strip is in its first and/or second position, the second end of the strip is provided outside of the housing.

This is advantageous in that, since the strip is visible during use, any defects in the shock absorber can be visibly identified.

Preferably the deformer member has a substantially arcuate surface and when the strip is moved from its first position to its second position, the at least a part of the first section of the strip is curved around at least a circumferential section of said arcuate surface.

Preferably said arcuate surface has a substantially constant radius. This is advantageous in that the strip is deformed into a curve having a substantially constant radius, which provides a consistent, linear, energy absorbing performance of the strip as it moves from its first position to its second position.

Preferably the arcuate surface is concave.

Preferably the deformer member comprises a substantially cylindrical bar. Preferably the cylindrical bar is rotationally mounted to the housing for rotation relative to the housing.

Preferably as the strip moves from its first position to its second position, respective sections of the strip that extend from the deformer member to the first or second ends of the strip are substantially parallel. Preferably said sections overlap.

Preferably as the strip moves from its first position to its second position, the at least part of the first section of the strip is curved around the deformer member through an angle of substantially 180°.

Preferably when the strip is in its first position, the strip extends from its first end, around at least a section of the deformer member, to its second end.

Preferably when the strip is in its first and/or second positions, sections of the strip that extend from the deformer member to the first or second ends of the strip respectively are substantially parallel and overlap each other.

Preferably when the strip is in its first and/or second positions, the strip is curved around the deformer member through an angle of substantially 180°.

Preferably the energy absorber comprises a first guide member which is arranged to guide the at least a part of the first section of the strip into contact with the deformer member as the strip moves from its first position to its second position.

The energy absorber may also comprise a second guide member which is arranged to guide the movement of the first section of the strip once it has been deformed by the deformer member.

Preferably the first and/or second guide members are arranged to constrain the movement of the strip around the deformer member, as the strip moves from its first position to its second position, such that the at least a part of the first section of the strip is substantially maintained in contact with the deformer member as it is passes around the deformer member. This is advantageous in that it ensures that the strip is deformed in a substantially uniform way around the deformer member, as it moves from its first position to its second position. This provides a consistent, and linear, deflection of the strip.

Preferably the first and second guide members are disposed on opposed sides of the deformer member.

Each of the first and/or second guide members preferably comprises a substantially cylindrical bar. Preferably the cylindrical bar is rotationally fixed relative to the housing.

Preferably the at least part of the first section of the strip is substantially the entire length of the first section of the strip, i.e. the extent of the first section of strip in its longitudinal direction. In this case, as the strip moves from its first position to its second position, substantially the entire length of the first section of the strip is moved into contact with the deformer member and is plastically deformed by the deformer member.

Preferably the first end of the strip is provided with an end stop that is arranged such that when the strip reaches its second position, the end stop prevents further movement of the strip in the direction from the first end to the second end of the strip. Preferably the end stop comprises a member which has a greater dimension in at least one direction than a corresponding dimension defined between opposed surfaces of the housing, such that the end stop is unable to pass through the housing.

Preferably when the strip is in its first position, a second section of the strip extends from an end of the first section of the strip that is distal to the first end of the strip, to the second end of the strip. The second section of the strip may be twisted to facilitate attachment of the attachment member to said second body.

According to a second aspect of the invention there is provided a fall arrest system comprising an energy absorber according to the first aspect of the invention, wherein the housing of the energy absorber is attached to a first body and the attachment member is attached to a second body.

Preferably the first body is a support structure, for example a structure of a building or a mounting member attached to a building (e.g. a mounting bracket) and the second body is a safety line member. Alternatively, the first body may be a safety line member and the second body said support structure.

The safety line member may be a substantially horizontal or substantially vertical safety line member.

Preferably the fall arrest system further comprises a harness for a person, said harness being attached to the safety line. Preferably the harness is slidably mounted to the safety line by a fall arrest traveller.

The fall arrest system may comprise a first said energy absorber and a second said energy absorber, attached at different points to the first and/or second bodies. For example, the housing of the first energy absorber may be attached to a structure of a building, with the attachment member attached to a first point on a safety line member and the housing of the second energy absorber may be attached to a structure of the, or another, building, with the attachment member attached to a second point on a safety line member. The first and second points may be spaced in a longitudinal direction of the safety line member.

All of the features described herein may be combined with any of the above aspects, in any combination.

Specific embodiments of the present invention will now be described, by way of example only, with reference to the accompanying drawings in which:

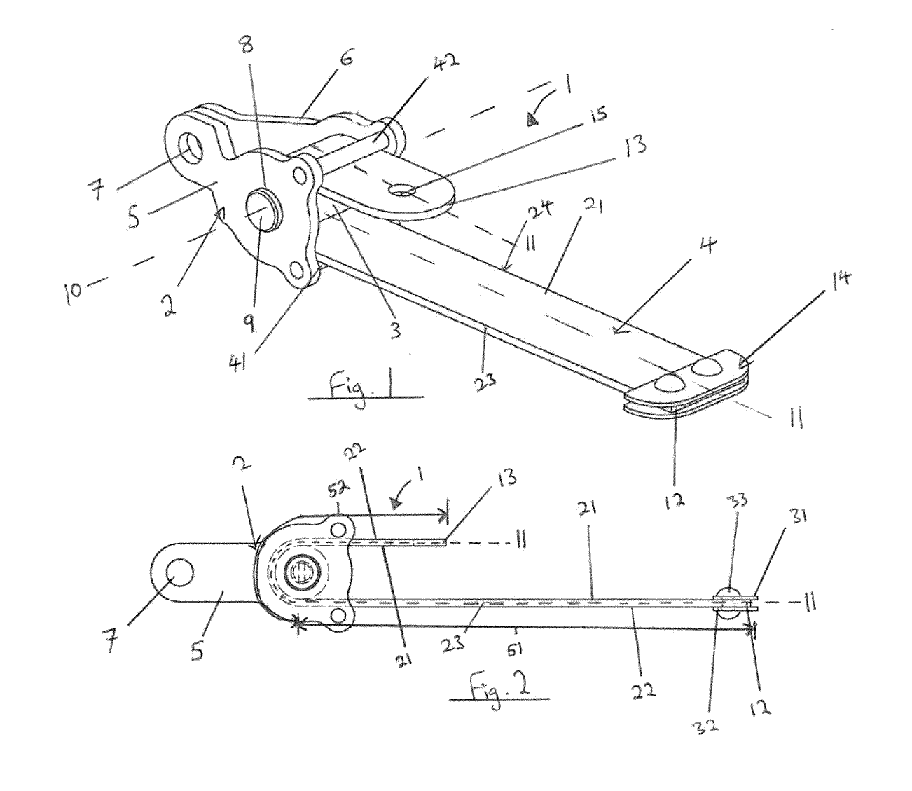

FIG. 1 shows a front perspective view of a fall arrest shock absorber according to a first embodiment of the present invention, with a deformable strip of the fall arrest shock absorber in a first position;

FIG. 2 shows a side elevational view of the fall arrest shock absorber of FIG. 1;

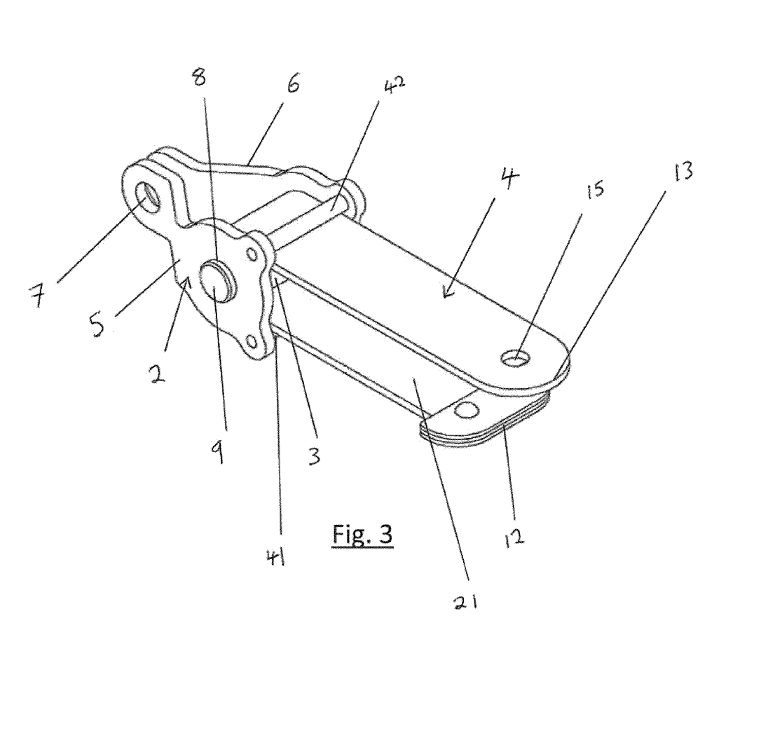

FIG. 3 shows a view corresponding to that of FIG. 1, but where the deformable strip of the fall arrest shock absorber is in a position intermediate the first position and a second position;

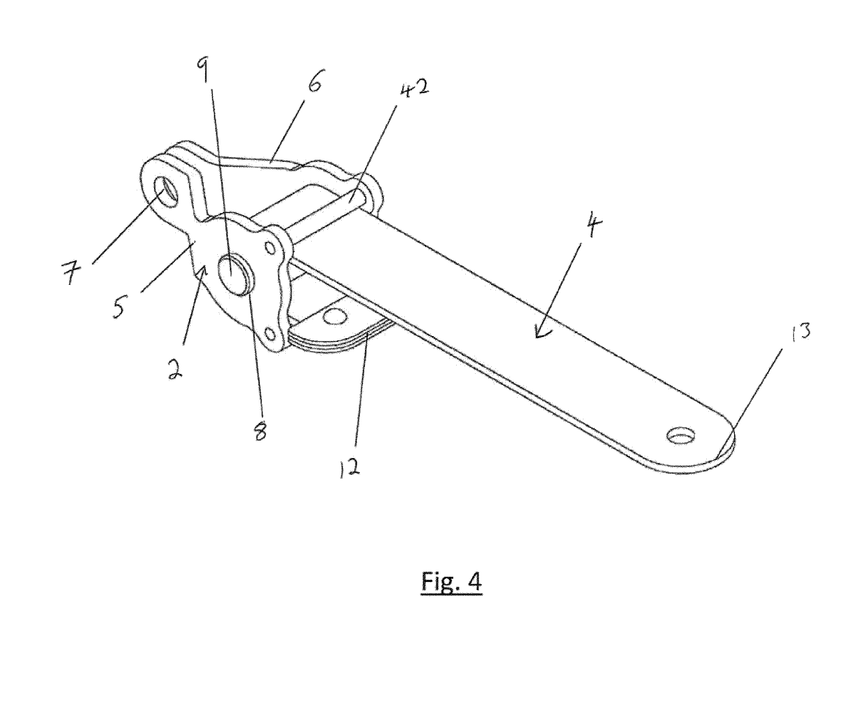

FIG. 4 shows a view corresponding to that of FIG. 1, but where the deformable strip of the fall arrest shock absorber is in a second position;

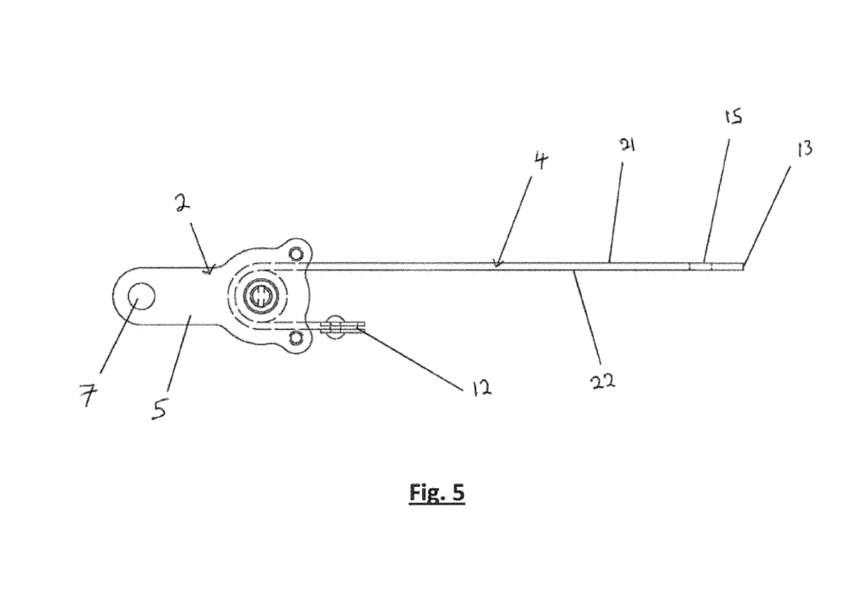

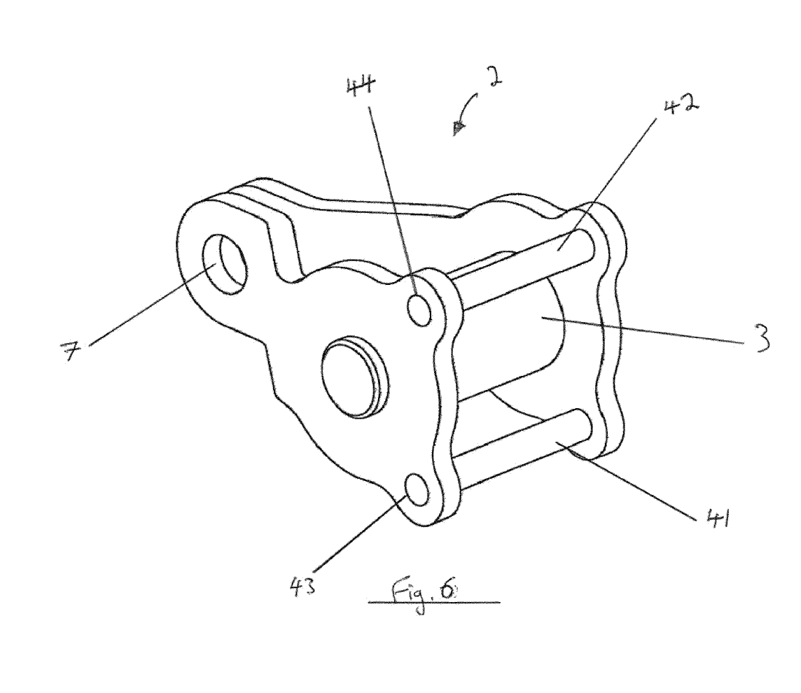

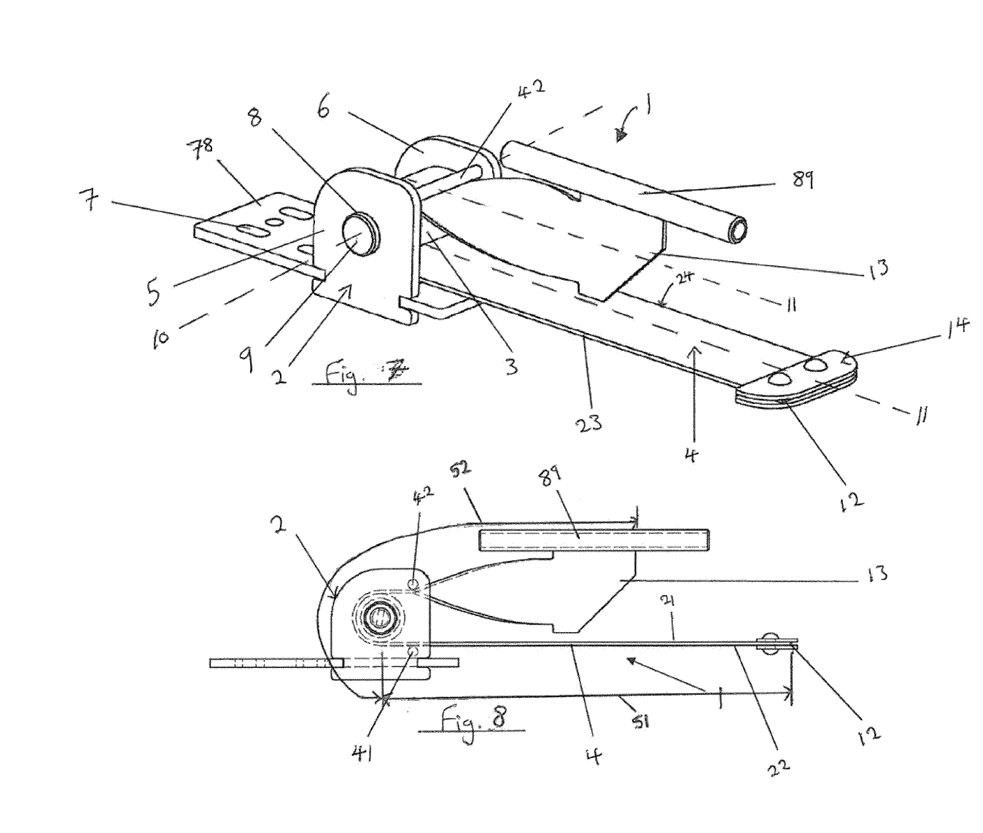

FIG. 5 shows a side elevational view of the fall arrest shock absorber of FIG. 4;

FIG. 6 shows a front perspective view of a housing of the fall arrest shock absorber shown in FIGS. 1 to 5;

FIG. 7 shows a front perspective view of a fall arrest shock absorber according to a second embodiment of the present invention, with a deformable strip of the fall arrest shock absorber in a first position;

FIG. 8 shows a side elevational view of the fall arrest shock absorber of FIG. 7;

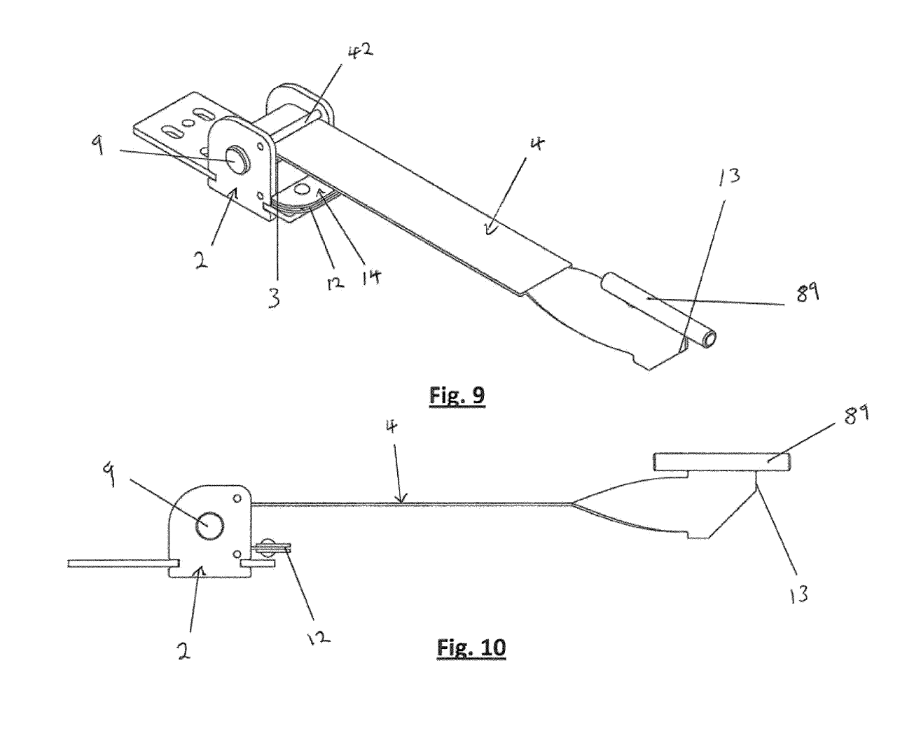

FIG. 9 shows a view corresponding to that of FIG. 7, but where the deformable strip of the fall arrest shock absorber is in a second position;

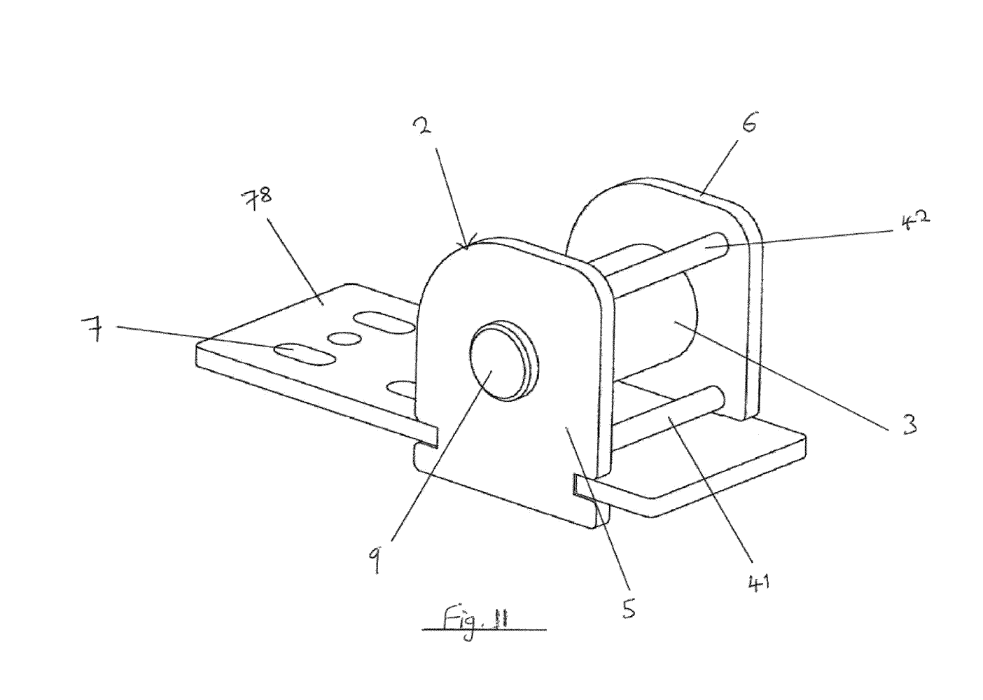

FIG. 10 shows a view corresponding to that of FIG. 8, but where the deformable strip of the fall arrest shock absorber is in a second position;

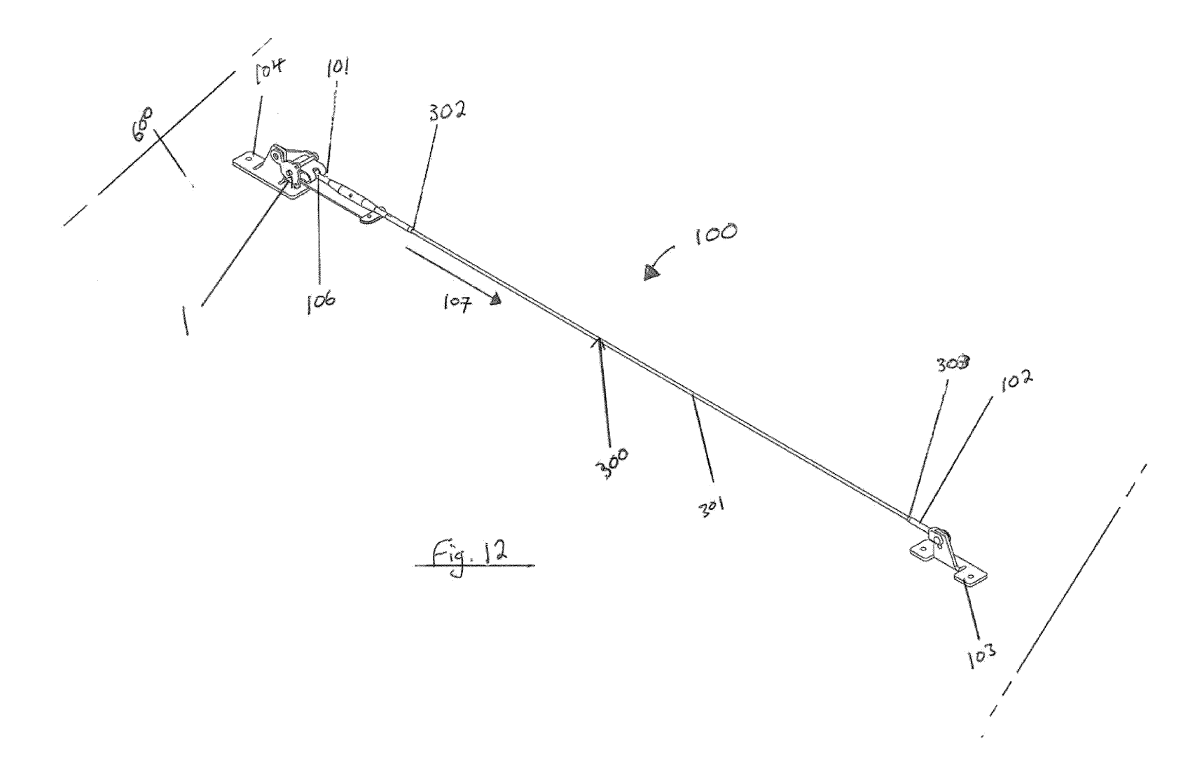

FIG. 11 shows a front perspective view of a housing of the fall arrest shock absorber shown in FIGS. 7 to 10;

FIG. 12 shows a fall arrest system comprising the fall arrest shock absorber of FIGS. 1 to 6, and

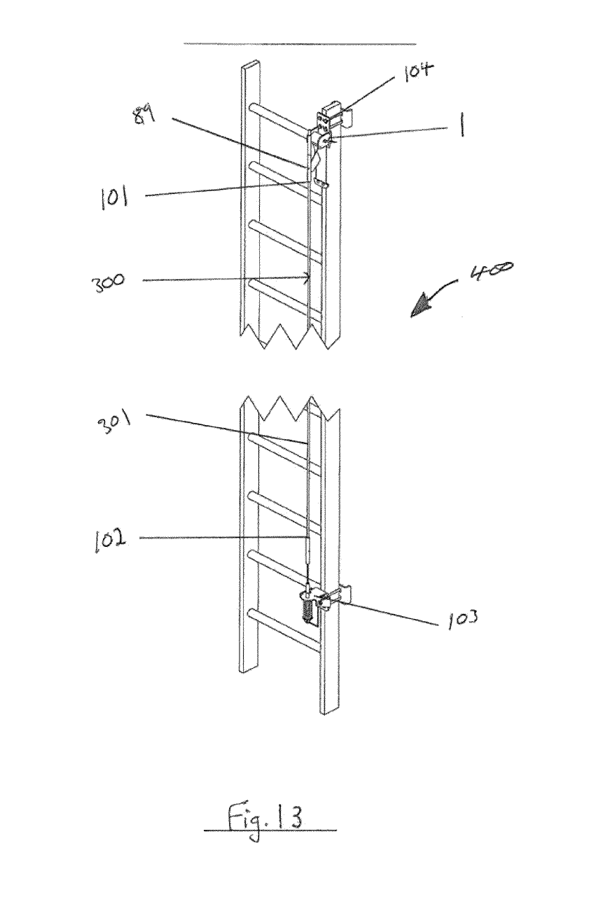

FIG. 13 shows a fall arrest system comprising the fall arrest shock absorber of FIGS. 7 to 11.

Referring to FIG. 12 there is shown a fall arrest system 100 comprising a substantially horizontal safety line member 300, which extends from a first end 101 to a second end 102 in a longitudinal direction. The first end 101 of the safety line member 300 is attached to a fall arrest shock absorber 1 according to a first embodiment of the present invention, which attaches the first end 101 of the safety line member 300 to a first mounting bracket 104. A second end 102 of the safety line member 300 is attached to a second mounting bracket 103. The first and second mounting brackets 104, 103 are mounted to a rigid support structure 600 of a building. In FIG. 12, the fall arrest shock absorber 1 is shown in a first (un-deployed) position, as discussed in more detail below.

The fall arrest system 100 further comprises a harness for a person (not shown), which is slidably mounted to the safety line member 300 by a fall arrest traveller (not shown). In use, a person is slidably attached to the safety line 300 by the fall arrest traveller, which travels along the safety line with the person, to allow the person to move around the structure they are working on, while remaining attached to the safety line member 300. If the person falls, the fall arrest traveller locks onto the safety line member 300 to arrest their fall. This causes the kinetic energy of the person's fall to be transmitted through the safety line member 300 to the first and/or second mounting brackets 104, 103.

Referring to FIGS. 1 to 6, there is shown a fall arrest shock absorber 1 according to a first embodiment of the present invention, which is the fall arrest shock absorber shown in the fall arrest system of FIG. 12. In FIGS. 1 and 2, a plastically deformable strip of the fall arrest shock absorber is shown in a first (un-deployed) position, as discussed in more detail below. In FIG. 3, the strip is shown in an intermediate position, between the first position and a second (deployed) position. In FIGS. 4 and 5 the strip is shown in a second (deployed) position.

The fall arrest shock absorber 1 comprises a housing 2, a deformer bar 3 mounted within the housing 2 and a plastically deformable strip 4.

The housing 2 is a generally elongate member that extends in a length direction from a first end to a second end, along a longitudinal axis. The housing 2 comprises first and second elongate plates 5, 6 which extend in a longitudinal direction from a first end to a second end. The first and second plates 5, 6 have substantially flat inner and outer surfaces. The first and second plates 5, 6 are substantially identical in shape and are spaced from each other in a lateral direction of the housing 2. The first and second plates 5, 6 are laterally opposed to each other and are aligned in the longitudinal direction of the housing 2. The inner surfaces of the first and second plates 5, 6 are opposed to each other.

Each of the first and second plates 5, 6 is provided, towards its first end, with a first aperture 7. The first apertures 7 are substantially circular and are substantially aligned with each other. The first apertures 7 are for receiving a fastener (not shown) to attach the housing 2 to a first body in the form of support structure, such as a mounting bracket attached to a rigid, load bearing structure of a building. Examples of a suitable fastener include a shackle, clevis pin and set screw and a locking nut, or any other suitable fastener.

Each of the first and second plates 5, 6 is provided, towards its second end, with a second aperture 8. The second apertures 8 of the plates 5, 6 are substantially circular and are substantially aligned with each other.

A locating pin 9 is received within the second apertures 8 in the first and second plates 5, 6. The locating pin 9 passes from the second aperture 8 in the first plate 5, across the width of the housing 2, into the second aperture 8 in the second plate 6. The locating pin 9 is substantially cylindrical in shape, having a longitudinal axis that is substantially perpendicular to the opposed inner surfaces of the first and second plates 5, 6. The locating pin 9 is rotationally mounted within the said second apertures 8.

The deformer bar 3 is a substantially cylindrical, substantially hollow, bar mounted on the locating pin 9, between the opposed inner surfaces of the first and second plates 5, 6. The deformer bar 3 extends along a longitudinal axis 10 that is substantially perpendicular to the opposed inner surfaces of the first and second plates 5, 6. The deformer bar 3 has a curved outer surface that is of substantially constant radius, i.e. it has a substantially circular cross-sectional shape. The deformer bar 3 is rotationally mounted on the locating pin 9. Accordingly, the deformer bar 3 is rotatable relative to the housing 2.

Each of the first and second plates 5, 6 is provided, at its second end, with third and fourth apertures 43, 44 (see FIG. 6). The third and fourth apertures 43, 44 are provided on opposite sides of the deformer bar in a height direction of the first and second plates 5, 6. The third and fourth apertures 43, 44 are substantially circular and the third and fourth apertures 43, 44 of the first plate 5 are substantially aligned with the third and fourth apertures 43, 44 of the second plate 6 respectively.

A first guide pin 41 is received within the third apertures 43 in the first and second plates 5, 6. The first guide pin 41 passes from the third aperture 43 in the first plate 5, across the width of the housing 2, into the third aperture 43 in the second plate 6. The first guide pin 41 is substantially cylindrical in shape, having a longitudinal axis that is substantially perpendicular to the opposed inner surfaces of the first and second plates 5, 6. First and second ends of the first guide pin 41 are rotationally fixed to the respective surfaces of the first and second plates 5, 6 that define the third apertures 43. Accordingly the first guide pin 41 is rotationally fixed relative to the housing 2.

Similarly, a second guide pin 42 is received within the fourth apertures 44 in the first and second plates 5, 6. The second guide pin 42 passes from the fourth aperture 44 in the first plate 5, across the width of the housing, into the fourth aperture 44 in the second plate 6. The second guide pin 42 is substantially cylindrical in shape, having a longitudinal axis that is substantially perpendicular to the opposed inner surfaces of the first and second plates 5, 6. First and second ends of the second guide pin 42 are rotationally fixed to the respective surfaces of the first and second plates 5, 6 that define the fourth apertures 44. Accordingly the second guide pin 42 is rotationally fixed relative to the housing 2.

The plastically deformable strip 4 is an elongate strip, with a substantially rectangular cross-sectional shape. The strip 4 extends in a length direction from a first end 12 to a second end 13 along a longitudinal axis 11 and in a width direction from a first side surface 23 to a second side surface 24 along a lateral axis. The first and second side surfaces 23, 24 extend in a thickness direction of the strip 4 (the direction perpendicular to the longitudinal and lateral directions).

The strip 4 has first and second opposed surfaces 21, 22 that extend between the first and second ends 12, 13 of the strip and between the first and second side surfaces 23, 24.

The strip 4 is made from steel. However, it will be appreciated that any suitable plastically deformable material may be used, including alloy steel or aluminium.

In FIGS. 1 and 2 the strip 4 is shown in a first position, which is the un-deployed position of the fall arrest shock absorber 1. In its first position, the strip 4 passes from its first end 12, into the housing 2, is curved around the deformer bar 3 and passes out of the housing 2, to its second end 13. The first and second ends 12, 13 of the strip 4 are located outside of the housing 2, on the same side of the housing 2 in the longitudinal direction of the housing 2.

A first longitudinal section 51 of the strip 4 is provided between the first end 12 of the strip 4 and the deformer bar 3, i.e. between the first end 12 of the strip 4 and the first point of contact of the strip 4 with the deformer bar 3. A second longitudinal section 52 of the strip 4 is extends from the end of the first section 51 that is distal to the first end 12 of the strip 4 to the second end 13 of the strip 4. The first section 51 of the strip 4 is substantially straight in its longitudinal direction 11.

As the strip 4 passes into the housing 2, it passes between the first guide pin 41 and the deformer bar 3. As the strip 4 passes out of the housing 2, it passes between the deformer bar 3 and the second guide pin 42.

The first and second guide pins 41, 42 are each spaced from the deformer bar, in the height direction of the housing 2, by a distance that is slightly greater than the thickness of the strip 4. The first and second guide pins 41, 42 are arranged to urge the first surface 21 of the strip 4 against a semi-circular section of the outer surface of the deformer bar 3, such that the strip 4 is deformed around said section of the outer surface of the deformer bar 3. As the strip 4 passes between the deformer bar 3 and the second guide pin 42 it is subsequently re-straightened such that that extends in parallel to the first section 51 of the strip 4, but in an opposite direction to the first section 51 of the strip 4. Accordingly, the strip 4 is bent through an angle of substantially 180°, around the deformer bar 3.

Opposed inner surfaces of the first and second plates 5, 6 of the housing 2 are spaced apart in the lateral direction of the housing 2 by a distance which is slightly greater than the width of the strip 4, so that the strip 4 is receivable between the inner surfaces of the first and second plates 5, 6 of the housing 2.

Towards its second end 13, the strip 4 is provided with an attachment member in the form of a substantially circular aperture 15 which extends through the thickness of the strip 4 from the first surface 21 to the second surface 22 of the strip 4. The aperture 15 is for attachment to the safety line member 300.

In order to attach the second end 13 of the strip 4 to the safety line member 300, the second end 13 of the strip 4 is folded about a line that bisects the aperture 15 and extends in the width direction of the strip 4, to present the aperture 15 in the longitudinal direction 11.

The safety line member 300 comprises an elongate flexible safety line 301 that extends from a first end 302 to a second end 303 in a longitudinal direction (see FIG. 12).

The first end 302 of the safety line 301 is attached to T-shaped member 106. The T-shaped member 106 comprises a central stem, which is attached to the first end 302 of the safety line 300 and extends in the longitudinal direction of the safety line 301. The T-shaped member 106 further comprises first and second feet, disposed at an end of the stem that is distal to the safety line 301, on opposed lateral sides of the stem, and that extend outwardly from the stem in respective directions that are substantially perpendicular to the central stem.

The first and second feet of the T-shaped member 106 are received within the aperture 15 in the second end of the strip 4. This securely attaches the first end 101 of the safety line member 300 to the second end 13 of the deformable strip 4.

As stated above, if a person attached to the safety line 300 falls, their fall is arrested by the safety line member 300 (for example a fall arrest traveller, to which the person is attached, locks onto the safety line 300), which causes the kinetic energy of the person's fall to be transmitted through the safety line 300.

The fall of the person exerts a force on the first end 101 of the safety line member 300, which has a component in the direction of the second end 102 of the safety line member 300, as shown by the arrow labelled 107 in FIG. 12. Due to the attachment of the T-shaped member 106 to the second end 13 of the strip 4, this acts to pull the second end 13 of the strip 4 in the direction of this for, away from away deformer bar 3, which moves the strip 4 from its first position, as shown in FIGS. 1 and 2, to a second position, as shown in FIGS. 4 and 5, via an intermediate position, shown in FIG. 3.

Specifically, as the second end 13 of the strip 4 is pulled away from the deformer bar 3 the strip 4 is pulled around the deformer bar 3, with the first end 12 of the strip 4 pulled towards the deformer bar 3. As the strip 4 moves, the first section 51 of the strip 4 is brought into contact with the outer surface of the deformer bar 3 and is deformed by the deformer bar 3 by being curved around the outer surface of the deformer bar 3. As the first section 51 of the strip 4 moves between the deformer bar 3 and the second guide pin 42, it is subsequently re-straightened such that it extends substantially in parallel with, but in an opposite longitudinal direction to the portion of the first section 51 of the strip 4 entering the housing 2. Accordingly, as the first section 51 of the strip 4 is moved from its first position to its second position, it is curvedly deformed through an angle of substantially 180°, around the deformer bar 3.

As the strip 4 is curved around the deformer bar 3, and then subsequently re-straightened, the strip 4 is plastically deformed. This plastic deformation absorbs energy of the fall of the person that is transmitted to the first end 101 safety line member 300. This decreases the impact force that is exerted on the first mounting bracket 104, thereby preventing damage to the mounting bracket 104.

The first and second guide pins 41, 42 are arranged to constrain the movement of the strip 4 around the deformer bar 3, as the strip 4 moves from its first position to its second position, such that the first section 51 of the strip 4 is substantially maintained in contact with said outer surface of the deformer bar 3 as it is passes around the deformer bar 3. This is advantageous in that it ensures that the strip 4 is deformed in a substantially uniform way around the deformer member, as it moves from its first position to its second position. This provides a consistent, and linear, deflection of the strip 4, which provides a consistent rate of energy absorption during the fall arrest.

The first end 12 of the strip 4 is provided with an end stop 14. The end stop 14 comprises first and second opposed plates 31, 32 that are respectively mounted on the first and second surfaces 21, 22 of the strip 4. The first and the second plates 31, 32 of the end stop 14 are attached to the strip 4, and to each other, by a pair of rivets 33 that passes through the first plate 31, through the thickness of the strip 4 and into the second plate 32. The first and second plates 31, 32 of the end stop 14 have a width that is greater than the width of the strip 4, with first and second lateral ends of the end stop 14 extending past the first and second side surfaces 23, 24 of the strip 4 respectively, in the width direction of the strip 4. In addition, the first and second plates 31, 32 of the end stop 14 are wider than the lateral distance between the first and second plates 5, 6 of the housing 2.

Accordingly, when the first end 12 of the strip 4 reaches the housing 2, as the strip 4 moves to its second position, the first and second plates 31, 32 of the end stop 14 abut against front faces of the first and second plates 5, 6 of the housing 2. This prevents any further movement of the strip 4 in said direction. The end stop 14 is arranged such that it is capable of supporting a load that is two and half times the maximum load experienced by the fall arrest shock absorber 1 as the strip 4 moves from its first position to its second position. For example, during deployment a peak value of 15 kN is typically exerted on the fall arrest shock absorber 1. Accordingly, the end stop 14 is sized, dimensioned and arranged, and made of a material, such that it is capable of supporting a load of 37.5 kN.

When the strip 4 is in its first position, the first section 51 of the strip 2 is shaped such that the first end 12 of the strip 4 is substantially exposed. In this respect, when the strip 4 is in its first position, the first section 51 of the strip 2 is shaped such that it does not substantially enclose the first end 12 of the strip 4. This is advantageous in that the length of the strip 4 can be easily varied, e.g. by attaching an additional length of strip to the first end 12 of the strip 4, or removing a length of strip from its first end 12. This enables the shock absorbing properties, for example the amount of energy absorbed and the deflection of the strip 4 for a certain level of force, to be varied as desired, in a quick, easy and reliable way.

When the strip 4 is in its first position, the first section 51 of the strip 4 is substantially flat in the longitudinal direction 11 of said first section 51 of the strip 4. The strip 4 is also substantially flat in its lateral (width) direction.

This is advantageous in that the fall arrest shock absorber 1 provides a consistent performance that can be accurately predicted according to the length of the strip 4. This provides a more linear force deflection graph, which has a larger area underneath its curve, relative to the known shock absorbers described above (in which the section of the strip that is disposed between the first end of the strip and the deformer member is wound in a coil that decreases in diameter decreasing during energy absorption). Accordingly, with the fall arrest shock absorber of the present invention more work is performed by the deforming material and so more energy is absorbed.

When the strip 4 is in its first position, the first end 12 of the strip 4 is exposed from the housing 2. In this respect, when the strip 4 is in its first position the first end of the strip is provided outside of the housing.

This is advantageous in that it allows easy access to the first end of the strip, so as to vary the length of the strip 4, without having to disassemble the housing. This allows the energy absorbing properties of the strip 4 to be varied quickly and easily, as desired.

When the strip 4 is in its first position, the second end 13 of the strip 4 is also exposed from the housing. This is advantageous in that, since the strip 4 is substantially visible during use, any defects in the strip 4 can be visibly identified, for example without having to disassembly the housing 2.

The outer surface of the deformer bar 3 has a substantially constant radius. This is advantageous in that the strip 4 is deformed into a curve of a substantially constant radius, which provides a consistent, linear, energy absorbing performance of the strip 4 as it moves from its first position to its second position.

Referring now to FIGS. 7 to 11, there is shown a fall arrest shock absorber according to a second embodiment of the present invention. In FIGS. 7 and 8, the strip 4 is shown in its said first position. In FIGS. 9 and 10 the strip 4 is shown in its said second position. Where features of the second embodiment are the same are the same as those of the first environment, like reference numerals have been used.

The fall arrest shock absorber of the second embodiment is the same as that of the first embodiment except in that it is adapted for use with a substantially vertical safety line member.

In this respect, the attachment member is formed by an elongate connecting rod 89 attached part way along its length to the second side surface 24 of the strip 4, towards the second end 13 of the strip 4.

Referring to FIG. 13 there is shown a fall arrest system 400 comprising a substantially vertical safety line member 300, which extends from a first end 101 to a second end 102 in a longitudinal direction. The first end 101 of the safety line 300 is attached to a fall arrest shock absorber 1 according to the second embodiment of the present invention, which attaches the first end 101 of the safety line member 300 to a first mounting bracket 104. A second end 102 of the safety line member 300 is attached to a second mounting bracket 103 (which in this case is spring damped). The first and second mounting brackets 104, 103 are mounted to a rigid support structure of a building (not shown). In FIG. 13, the fall arrest shock absorber 1 is shown in said first (un-deployed) position.

The fall arrest system 400 further comprises a harness and fall arrest traveller, as in the fall arrest system shown in FIG. 12.

The connecting rod 89 of the fall arrest shock absorber 1 attaches the second end 13 of the strip 4 to the first end 101 of the safety line member 300, as shown in FIG. 13.

In this embodiment, the second section 52 of the strip 4 is twisted about its longitudinal axis 11 so as to align the connecting rod 89 with the safety line member 300.

In this embodiment, the first apertures 7, for receiving a fastener (not shown) to attach the housing 2 to a first body in the form of support structure, such as a rigid, load bearing structure of a building, are not received in the first and second plates 5, 6 (as in the first embodiment), but are received in a mounting plate 78 that extends between the first and second plates 5, 6 at a lower end of the plates 5, 6.

Apart from the above differences, the fall arrest shock absorber 1 of the second embodiment has substantially the same structure, and works in substantially the same way, as the fall arrest shock absorber 1 of the first embodiment.

In view of the above, it can be seen that the fall arrest shock absorber of the invention provides an inexpensive and easily adaptable shock absorber that is very efficient for its low cost.

The described and illustrated embodiments are to be considered as illustrative and not restrictive in character, it being understood that only the preferred embodiments have been shown and described and that all changes and modifications that come within the scope of the inventions as defined in the claims are desired to be protected.

For example, in the above described embodiments of the invention, the second end 13 of the strip 4 is attached to a safety line member 300 and the housing 2 is attached to a support structure (such as a rigid, load bearing structure of a building). However, it will be appreciated, that in a reciprocal arrangement, the second end 13 of the strip 4 may attached to a support structure (such as a rigid, load bearing structure of a building) and the housing 2 attached to the safety line member 300.

The fall arrest systems 100, 400 described above comprises only a single fall arrest shock absorber 1 of the first or second embodiments respectively, to attach the first end 101 of the safety line member 300 to the first mounting bracket 104. Alternatively, or additionally, a second said fall arrest shock absorber may be used to attach the second end 102 of the safety line member 300 to the second mounting bracket 103.

In the described embodiments, when the strip 4 is in its first position, it passes from its first end 12, into the housing 2, around the deformer bar 3 and back out of the housing 2. Alternatively, when it is in its first position, the strip 4 may not pass around the deformer bar 3, but may be guided by a suitable guide arrangement such that when it is moved from its first position to second position, it passes around the deformer bar 3 and is deformed by the deformer bar 3.

Furthermore, in the currently described embodiments, when the strip 4 moves from its first position to second position, substantially the entire length of the first section 51 of the strip 4 is brought into contact with the deformer bar 3 and is deformed by the deformer bar 3. Alternatively, the strip 4 and deformer bar 3 may be arranged such that when the strip 4 is moved from its first person to its second position, only a portion of the first section 51 of the strip 4 is deformed by the deformer bar 3.

It should be understood that while the use of words such as “preferable”, “preferably”, “preferred” or “more preferred” in the description suggest that a feature so described may be desirable, it may nevertheless not be necessary and embodiments lacking such a feature may be contemplated as within the scope of the invention as defined in the appended claims. In relation to the claims, it is intended that when words such as “a,” “an,” “at least one,” or “at least one portion” are used to preface a feature there is no intention to limit the claim to only one such feature unless specifically stated to the contrary in the claim. When the language “at least a portion” and/or “a portion” is used the item can include a portion and/or the entire item unless specifically stated to the contrary.

1. An energy absorber comprising a housing for attachment to a first body, a deformer member mounted to the housing, a strip of plastically deformable material extending in a longitudinal direction between first and second ends, an attachment member provided at or towards, the second end of the strip for attachment to a second body, the strip being arranged with the deformer member such that when a predetermined force is applied to the attachment member the strip is moved relative to the deformer member from a first position, in which a first section of the strip extends from the first end of the strip to the deformer member, to a second position such that as the strip is moved from its first position to its second position at least a part of the first section of the strip is plastically deformed by the deformer member, wherein the strip is arranged such that when it is in its first position, the first section of the strip is substantially flat in the longitudinal direction of the first section of the strip, and,
wherein the energy absorber comprises a first guide member which is arranged to guide the at least a part of the first section of the strip into contact with the deformer member as the strip moves from its first position to its second position, and
wherein the energy absorber comprises a second guide member which is arranged to guide the movement of the at least part of the first section of the strip once it has been deformed by the deformer member.

2. An energy absorber according to claim 1 wherein when the strip is in its first position, the first section of the strip is substantially flat in a lateral direction of the first section of the strip.

3. An energy absorber according to claim 1 wherein the strip is arranged such that when it is in its first position, the section of the strip does not substantially enclose the first end of the strip.

4. An energy absorber according to claim 1 wherein when the strip is in its first position and/or second position, the first end of the strip is exposed from the housing.

5. An energy absorber according to claim 4 wherein when the strip is in its first and/or second position, the first end of the strip is provided outside of the housing.

6. An energy absorber according to claim 1 wherein when the strip is in its first and/or second position, the second end of the strip is exposed from the housing.

7. An energy absorber according to claim 6 wherein when the strip is in its first and/or second position, the second end of the strip is provided outside of the housing.

8. An energy absorber according to claim 1 wherein the deformer member has a substantially arcuate surface and when the strip is moved from its first position to its second position, the at least a part of the first section of the strip is curved around at least a circumferential section of said arcuate surface.

9. An energy absorber according to claim 8 wherein said arcuate surface has a substantially constant radius.

10. An energy absorber according to claim 1 wherein when the strip is in its first position, the strip extends from its first end, around the deformer member, to its second end.

11. An energy absorber according to claim 1 wherein when the strip is in its first and/or second positions, sections of the strip that extend from the deformer member to the first or second ends of the strip respectively are substantially parallel.

12. An energy absorber according to claim 1 wherein when the strip is in its first and/or second positions, sections of the strip that extend from the deformer member to the first or second ends of the strip respectively overlap each other.

13. An energy absorber according to claim 1 wherein when the strip is in its first and/or second positions, the strip is curved around the deformer member through an angle of substantially 180°.

14. (canceled)

15. (canceled)

16. An energy absorber according to claim 1 wherein the first and/or second guide members are arranged to constrain the movement of the strip around the deformer member, as the strip moves from its first position to its second position, such that the at least a part of the first section of the strip is substantially maintained in contact with the deformer member as it is deformed by the deformer member.

17. An energy absorber according to claim 1 wherein the at least part of the first section of the strip is substantially the entire length of the first section of the strip.

18. An energy absorber according to claim 1 wherein the first end of the strip is provided with an end stop that is arranged such that when the strip reaches its second position, the end stop prevents further movement of the strip in the direction from the first end to the second end of the strip.

19. An energy absorber according to claim 18 wherein the end stop comprises a member which has a greater dimension in at least one direction than a corresponding dimension defined between opposed surfaces of the housing, such that the end stop is unable to pass through the housing.

20. An energy absorber according to claim 1 wherein when the strop is in its first position, a second section of the strip extends from an end of the first section of the strip that is distal to the first end of the strip, to the second end of the strip.

21. An energy absorber according to claim 20 wherein the second section of the strip is twisted to facilitate attachment of the attachment member said second body.

22. A fall arrest system comprising an energy absorber according to claim 1, wherein the housing of the energy absorber is attached to a first body and the attachment member is attached to a second body.

23. A fall arrest system according to claim 22 wherein the first body is a support structure, and the second body is a safety line member, or vice versa.

24. A fall arrest system according to claim 22 wherein the fall arrest system comprises a first said energy absorber and a second said energy absorber, attached at different points to the first and/or second bodies.

25. (canceled)

26. (canceled)

27. A fall arrest system comprising an energy absorber, the energy absorber comprising a housing attached to a first body, a deformer member mounted to the housing, a strip of plastically deformable material extending in a longitudinal direction between first and second ends, an attachment member provided at, or towards, the second end of the strip, the attachment member attached to a second body, the strip being arranged with the deformer member such that when a predetermined force is applied to the attachment member the strip is moved relative to the deformer member from a first position, in which a first section of the strip extends from the first end of the strip to the deformer member, to a second position such that as the strip is moved from its first position to its second position at least a part of the first section of the strip is plastically deformed by the deformer member, wherein the strip is arranged such that when it is in its first position, the first section of the strip is substantially flat in the longitudinal direction of the first section of the strip.
